(19) United States
(12) Patent Application Publication
(10) Pub. No.: US 2002/0131565 A1
(43) Pub. Date: Sep. 19, 2002

(54) Calendaring systems and methods

(76) Inventors: Jerome James Scheuring, Carmel, CA (US); Sylvia Tidwell Scheuring, Carmel, CA (US); Darlene Waddington, La Crescenta, CA (US)

Correspondence Address: SQUIRE, SANDERS & DEMPSEY L.L.P, 600 HANSEN WAY, PALO ALTO, CA, 94304-1043, US

(21) Appl. No.: 10/071,463

(22) Filed: Feb. 9, 2002

Related U.S. Application Data
(60) Provisional application No. 60/267,814, filed on Feb. 9, 2001.

(51) Int. Cl. H04M 1/64

(52) U.S. Cl. 379/88.19; 379/67.1

(57) ABSTRACT

A calendaring system communicatively coupled to a network comprises: a calendar engine capable to store and display event data from a calendar database; a portrait database capable to store portraits of users; the portraits including relationship settings for users; and an event engine, communicatively coupled to the calendar engine and portrait database, capable of scheduling events (including implicit events), sending events invitations and responding to an event invitation received, and offering appropriate services related to those events, via the network, as a function of time availability as indicated in the calendar database, relationship settings, and lifestyle wishes, monitors and gauges of the participants in the event as indicated in the portrait database.

### PRIORITY REFERENCE TO PRIOR APPLICATION

This application claims benefit of and incorporates by reference U.S. provisional patent application serial No. 60/267,814, entitled “Matching System Systems and Methods,” filed on Feb. 9, 2001, by inventors Jerome James Scheuring, Sylvia Tidwell Scheuring, and Darlene Waddington.

### TECHNICAL FIELD

This invention relates generally to calendar systems and methods, and more particularly, but not exclusively, provides systems and methods for intelligent calendaring.

### BACKGROUND

Conventional electronic calendars enable users to schedule events, such as meetings, telephone conferences, birthday parties, etc. In addition, some conventional electronic calendars enable a user to invite other users, to send invitations to events and receive responses such as “accept”, “decline”, and “reschedule”. The only kind of interaction the calendars provide is to give you notification of event proximity. The calendars do not provide intelligent decision-making, i.e. they will let you schedule back-to-back meetings in two different countries. Everything that the calendar stores is explicitly provided by somebody and they do not take into account implicit events related to explicit (e.g. travel time) and implicit states of mind (e.g. stress level . . . the amount of time needed to prepare for an event). A new method is needed to truly add a level of convenience to people's busy scheduling needs.

Our method is based upon profiles of the calendar users and the explicit calendar entries. These profiles have many facets of meaning, which are then compared and analyzed to determine the implicit events and courses of action necessary for the explicit event to occur. Subsequently, our calendar system determines the best time(s) to schedule or reschedule an event. It also provides triggers to remind the user or to facilitate the acquisition of supplementary services that will help expedite the event (e.g. filling the gas tank before leaving on a road trip). It also directly provides Triggered Services that will help expedite the event (e.g. calculating a realistic drive time based upon a number of variables such as urbaness, weather, and time of day). This calculation is performed by the drive time calculation engine.

### SUMMARY

The present invention provides a system for life management using calendaring. The system comprises a calendaring engine; an event engine; a life manager engine; a portrait gallery engine; a voicemail engine; a call scheduler engine; a drive time calculation engine, and an information gathering engine. The calendaring engine enables a user to enter data into three default calendars including a business calendar, personal calendar, and chores calendar. A user can also have any number of additional calendars such as: family, friends, hobbies, community events, pet care, TV watching, doctor's appointments, customer calls, travel, church activities, care taking schedules, medication schedules, sporting events, and car maintenance. The calendaring engine enables a user to view the calendars in multiple formats, such as previous and upcoming days, weeks, months, and years. In addition the calendaring engine enables a user to view daily, weekly and monthly calendars. They can also view any composite of their calendars, e.g. merging work and personal calendars to view the activities in any time period. When in a daily view, the calendaring engine indicates events by type for easy view. In one embodiment, this would be color coding; shading blocks of work time; and tinting new events or newly bumped events. In another embodiment of the invention, the calendaring engine can cause new or newly bumped events to blink or become italicized . . . something to catch the viewer's attention. In a non-graphical environment, this might be a beeping tone or a different tone of voice.

The event engine enables a user to schedule an event. This may include a plurality of participants. A user can schedule an event using an event template or schedule an event without the use of a template. Event templates make it easy for users to schedule complex events; they walk the scheduler through the steps necessary to cover any related services and to assign meaning to the event for life management purposes. Some Event Templates can be pre-defined and/or users can save events they modify from these pre-defined Event Templates.

The user can create the profile of an event by specifying the event attributes, such as day, time frame, event beginning time, event ending time, amount of time, required and optional participants, level of importance for the event, stress level, event mode, event type, and event location. The user may instead choose to enter ranges and/or sets of options instead of specifying particulars, and then the system will choose the best attributes for the participants of the event.

Importance can be indicated using a numbering system or a more verbal indicator: for example, “Urgent! Make it happen ASAP!,” “If it Slips, no Biggie,” and “Schedule Sometime between Now and When Hell Freezes Over.”

Event modes define frequency, movability, potential external influences, and overlap attributes of time scheduling for a particular event. They include: “One Time Only” (mutually exclusive of Recurring); “Recurring, (happens on a regular schedule)” “Multitasking” (can be done at the same time as other events, like being home for the plumber to come, etc); “Mobile” (can be done while driving to grocery store, etc.); “Shoehorn” (events that can be scheduled or rescheduled dynamically around more important events), and “Outdoor” (weather affects outdoor events).

Event Types help define the nature of an event, such as its likely participants, its likely stress level, its likely needed supplementary services, and its likely dependencies. They include: “Business,” “Personal,” “Family,” “Friends,” “Family and Friends,” “Romantic,” “Pet duty,” “Plant duty,” “Chore,” “Illness/Hospital Stay,” “Downtime,” “Trip,” “Dining Out,” “Dining In,” “Entertainment Out,” and “Entertainment In.” The nature of the pre-defined Event Types vary, depending on the profile of the user and other participants of the event, e.g. a workaholic might really relish a Business event, whereas a shut-in might dread it.

Users can specify the location or possible set of locations for an event as the Event Location. They can define the location in a variety of ways, including typing in the location(s) name and address (if not using an Event Template); choosing from a list of locations recommended by the system, based on previous user choices that match Event Type, intent, time frame, and involved parties (if not using an Event Template); typing in the event's name and the system searching an online resource such as online Yellow Pages to locate the address (if using an Event Template), or by choosing a location based upon a list of suggestion from some other triggered service in the system, such as Dining Out, Business Meeting, Team Meeting, PTA potluck, doctor's appointment, or travel planning (if using an Event Template).

Users can revise the attributes of the Event Profiles, some of which may in turn affect how an event is scheduled. They can revise such things as: different levels of importance for events; the Event Mode; Event Type; Event Priority, and Event Location.

In addition, the user can revise any of the specified information and also bump the event in a variety of ways, such as: selecting a proposed bump day; selecting a proposed bump time frame (in days or months), or selecting a proposed bump time frame (during a given day) in which an event should occur. The system will notify participants that an event has been bumped. It will also notify the participants if other involved parties cannot bump the event, thus giving them the option to drop out of an event, cancel an event, or further bump the event.

In an alternative embodiment, the event engine can access invitees' calendars and propose a bump day and time by checking the participants' schedules and lifestyle management preferences. If a user receives an invitation for an event, the user can accept or decline the invitation or have the event engine automatically determine whether to accept or decline based on the user's calendar. In another embodiment, if the system detects a need to bump an event, it can also bump events by checking for the participants of the event, checking the participants' schedules and lifestyle management preferences, and then automatically bumping the event.

The life manager engine manages time so that users can maintain a certain lifestyle that they desire. It enables a user to set lifestyle intentions such as “Stop the World,” “Ramp It Up,” “More Family Time,” “Business is Priority Number One,” “Find Time for my Friends,” and “I Need More Romance in My Life.”

Further, the life manager enables a user to set their ideal number of hours of sleep; ideal number of daily meals; weekly work schedule; work address so as to calculate drive time; set preferences on meters/gauges (such as a free time gauge; “stress-o-meter”; family time gauge; and “love-o-meter”) to warn a user when values exceed or fall below set preferences. In an alternative embodiment, the system generates a list of likely settings for all of the above-mentioned daily/weekly routines and allows the user to edit these settings. In an alternative embodiment, the Life Manager can select appropriate life setting and gauges based on user profile and allow them to be edited by the user.

Ultimately, the life manager will not allow the user to schedule events in a way that is unrealistic without first warning the user. For example, the life manager will attempt to make sure that the user sometimes sleeps and takes breaks for food and other basic comforts. It also makes sure that the user won't unintentionally schedule two events simultaneously or very close together in two cities or schedule similar events that appear to be simply impossible. This is made possible by keeping track of both the explicit events and implicit events tied to the explicit events.

The life manager engine also provides task wizards to enable a user to define who in each family can do which tasks, such as picking up children from school and how long tasks generally take. In an alternative embodiment, according to the user profile, the system generates a list of likely tasks, with attributes such as likely participants, likely times, and likely amounts of time needed to do them. Such tasks may be: buy groceries, cook meals, feed pets, mow the lawn, pick up the kids from school, take out the trash, and walk the dog.

The life manager engine can control how incoming events are prioritized, accepted, or rejected based on lifestyle intentions that were set by a user. Further, the life manager engine can prioritize, accept, or reject incoming events based on implicit events related to the incoming event, such as travel time, meals, necessary breaks; sleep schedule; weather; family/pet distractions; casual vs. business meetings; alertness factor; and optimum driving/commuting times.

The meters/gauges measure the relative amount of time spent on different types of activities. Meters such as the “free time gauge” and “family time gauge” measure the percentage of time allocated to this Event Type, calendar or calendar set by the life manager vs. the amount of time actually used for this Event Type, calendar or calendar set. Meters such as the “stress-o-meter” and “love-o-meter” measure event attributes such as stress or romance vs. the level desired by the user. Meter measurements are the average for the time being viewed by the user.

As an example, several somewhat stressful events scheduled back-to-back without relief will create a sum total of higher stress into a user's “stress-o-meter.” Also, one intensely romantic evening might suffice to meet a user's desired setting on the “love-o-meter.” The portrait gallery engine maintains contact information and/or profiles for other users. A user may enter data about users into a portrait gallery database. Alternatively, or in addition, the engine may import contacts from Outlook and/or vCards from email or other data acquisition techniques. A user can define contacts by including such information as type of living organism (e.g., adult; dependent adult; child; dependent child; baby; animal/pet; etc.), the user's emotional relationship to the contact, and traditional relationship (romantic, friend; business colleague; etc.). In addition, the portrait gallery engine enables the user to form groups of contacts and define information about the groups similarly to defining information about individual contacts.

User's emotional relationships can be defined numerically or by verbal-type definitions, such as: “Which part of the restraining order don't you understand?!”; “A time hog—pencil in only when my schedule isn't tight.”; “My old friend who's seen me at my best and worst. Schedule in whenever.”; “A neutral relationship. No particular issues to factor in.”; “Image is important. I must be at my best with you”; “I really enjoy being with you, the more the merrier,” and “The love of my life, I always have time for you.”

The voicemail engine is a triggered service (an service triggered by the event engine) and uses Event Templates to determine whether to let a phone call ring through or go to voicemail. This decision is based on criteria such as the user's defined emotional and traditional relationships with the caller, the profile of the event currently scheduled on the user's calendar (e.g. are they in the middle of a stressful meeting?) as well as the user's lifestyle setting

If the phone call is to go to voicemail, the voicemail engine determines the appropriate answering machine message to play based on criteria such as the caller's traditional and emotional relationship, user's lifestyle setting, the profile of the event currently scheduled on the user's calendar, and available time for rescheduling according to the user's calendar. The voicemail may then trigger an Event Template which would allow the caller to schedule a follow-up call.

The call scheduler engine, also a Triggered Service, works similarly to the voicemail event engine in that it enables a user to schedule a telephone conference with multiple invitees and reschedule if an invitee isn't available to make the conference. The rescheduling can be based on criteria such as a user's preference and upon invitees' availability according to their calendars. The call scheduler also allows attendees to attach files pertaining to the event (e.g. voice-mail, e-mail, and documents) to the attendees' calendars.

The methods of the present invention are based upon profiles of the calendar users and the explicit calendar entries. These profiles have many facets of meaning, which are then compared and analyzed to determine the implicit events and courses of action necessary for the explicit event to occur. Subsequently, our calendar system determines the best time(s) to schedule or reschedule an event. It also provides triggers to remind the user or to facilitate the acquisition of supplementary services that will help expedite the event (e.g. filling the gas tank before leaving on a road trip). It also directly provides Triggered Services that will help expedite the event (e.g. calculating a realistic drive time based upon a number of variables such as urbaness, weather, and time of day). This calculation is performed by the drive time calculation engine.

A second method comprises: scheduling an event or telephone conference; sending invitations to invitees; receiving responses from invitees; notifying the moderator (inviter) of the responses; receiving the inviter' determination regarding scheduling of meeting based on the responses; notifying the invitees of cancellation if the inviter so determines; proposed rescheduling of the event by repeating the above steps; or dropping the invitee and continuing with scheduling method. If the invitee is dropped, the method further comprises notifying the invitee of being dropped. Whether or not the invitee is dropped, the method further comprises sending reminders to the remaining invitees; notifying the moderator to start the call; providing schedule status update to the invitees; notifying invitees to start the call at the scheduled time; receiving invitee availability; notifying the moderator about real time invitee availability; enabling the moderator to determine whether to cancel the call due to unavailability of some invitees, bump the call, or continue the call; starting the call; and sending a list of participants to all invitees or only call participants.

When an event engine or Triggered Service requires external data that isn't available within the Event Template, the information gathering engine may be used to acquire the data. It gathers information from databases that are stored locally and/or remotely and feeds the requested information back to the event engine or service requesting the data.

The following scenario gives an example of an embodiment of several event engines requesting such information:

Scenario 1: Alice's Lunch Appointment with Bob

Assume for this scenario that a user, Alice, lives in a home with DSL, an OSGi-compliant gateway, a personal computer, and a few smart appliances such as her home thermostat. Similarly, assume that the information engine has access to “yellow pages” directory service, and a mapping and route planning service.

The scenario begins when Alice, a freelancer who works out of a home office, sets up a lunch appointment with her client, Bob. Alice enters the appointment on her calendar interface on her Web browser. The calendar notifies the system of Alice's intent to have lunch with Bob on Thursday.

As it happens, the two parties have previously agreed on a meeting time, so there is not a need for the system to propose one. However, Alice has not specified a location for the meeting, the information engine interrogates the Portrait Repository for information about Alice and Bob's restaurant preferences, and the usual reasons for having lunch—Alice is a vendor for Bob's company, so it's likely to be a business lunch—and their expected locations just before lunchtime.

The event engine uses the results from the Portrait Repository to select an appropriate planning template for the lunch date, and then uses the template to produce a plan for the event, including suggesting a restaurant, finding location data for that restaurant, making reservations, modifying Alice's schedule accordingly, and notifying Alice's environment of her comings and goings.

First, the event engine finds a restaurant that matches the parameters of the appointment. Fong's Chinese Restaurant on Sutter is the best match, so the event engine offers it as a suggestion, and Alice approves the choice.

Next, the information engine queries a commercial geographical information service—an example of a Triggered Service—for the location of Fong's restaurant with respect to Alice's home. The geographical information service responds with a location, a drive time estimate, and driving directions from Alice's house. This information is interpreted, by the Drive Time Calculation Triggered Service, with respect to local conditions. For example, the 94108 ZIP code is an extremely urban area, so additional time will be required for travel and parking.

The event engine then instructs a commercial automated call service—another example of a Triggered Service—to make reservations at Fong's for two persons at 1:00 p.m. The calendar engine enters the resulting complex list of events—travel time, lunch itself, and the return trip—into Alice's calendar.

Since one of the locations involved in Alice's lunch appointment is her home, her home environment is also notified of her comings and goings, another example of a Triggered Service. In this case, her home heating and cooling system is shut down while she's away, and later returned to her preferred temperature in time for her return.

Note, by the way, that in all of this, from Alice's perspective, she entered a lunch appointment on her calendar, and, a few moments later, responded to a message asking if Fong's was appropriate. Then she left for lunch, and, a few hours later, came home to a home heated to an appropriate temperature—all with a minimum of input on Alice's part.

Therefore the systems and methods advantageously enable a user to more effectively manage his or her life and scheduled time.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating a system in accordance with an embodiment of the present invention;

FIG. 2 is a block diagram illustrating an example computer for use with an embodiment of the present invention;

FIG. 3 is a flowchart illustrating a method for processing a received event invitation;

FIG. 4 is a flowchart illustrating a method for processing a phone call;

FIG. 5 is a flowchart illustrating a method for arranging and holding a telephone conference;

FIG. 6 is a flowchart illustrating a method for scheduling a telephone conference;

FIG. 7 is a diagram illustrating an example graphical user interface (GUI) for calendar selection;

FIG. 8 is a diagram illustrating an example GUI for scheduling an event;

FIG. 9 is a diagram illustrating an example GUI for selecting a lifestyle intention;

FIG. 10 is a diagram illustrating an example portrait GUI for a contact;

FIG. 11 is a diagram illustrating an example GUI 1100 illustrating impact of delaying a scheduled telephone conference based on invitees' availability; and

FIG. 12 is a flowchart illustrating a method for calculating a realistic drive time to, between or from scheduled events.

### DETAILED DESCRIPTION OF THE ILLUSTRATED EMBODIMENTS

The following description is provided to enable any person skilled in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

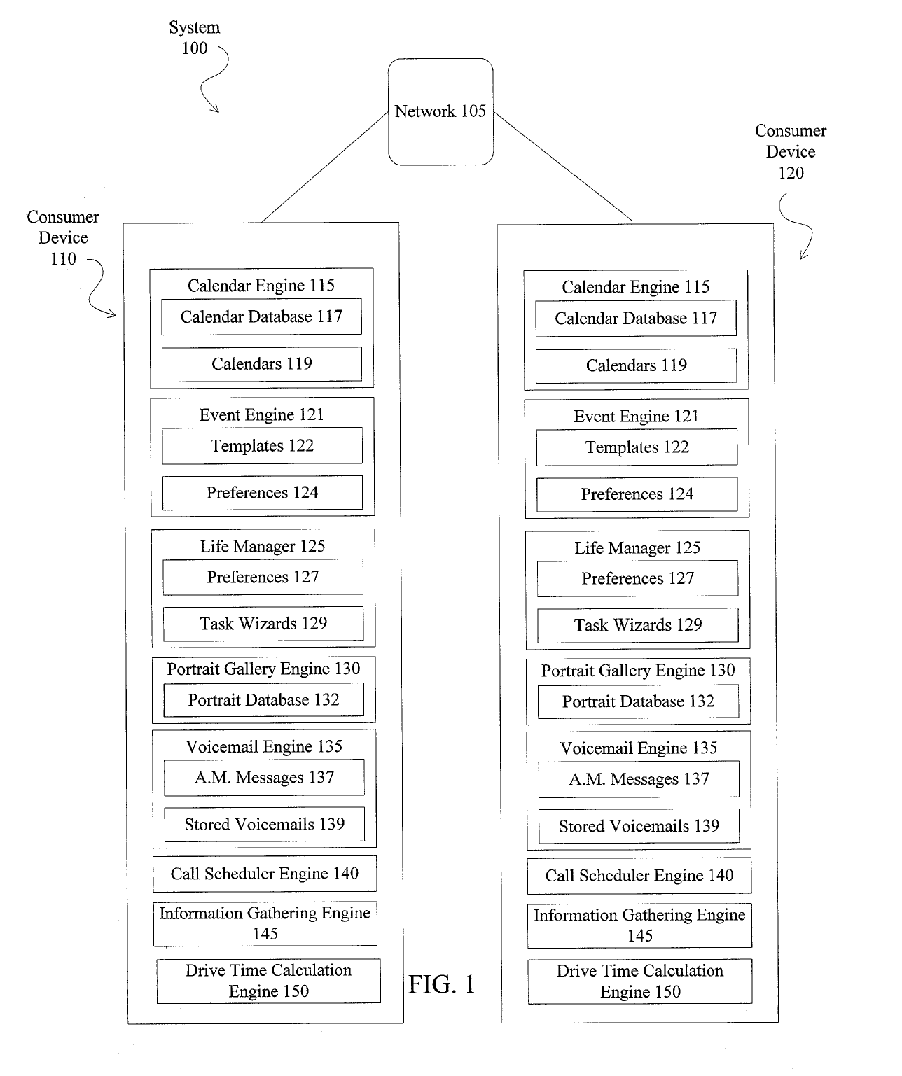

FIG. 1 is a block diagram illustrating a system 100 in accordance with an embodiment of the present invention. System 100 comprises a first consumer device 110 and second consumer device 120, both communicatively coupled (wired or wirelessly) to network 105 so that they may communicate with each other. In another embodiment of system 100, consumer device 110 and consumer device 120 are communicatively coupled directly to each other without network 105. Consumer device 110 may include a laptop computer, desktop computer, personal digital assistant, cell phone, or any other device capable to communicate with other devices and display data. Consumer device 120 may be substantially similar to consumer device 110.

Consumer device 110 includes a calendar engine 115; an event engine 121; a life style manager 125; a portrait gallery engine 130; a voicemail engine 135; a call scheduler engine 140; an information gathering engine 145; and a drive time calculation engine 150. In an embodiment of the invention, the engines may instead reside on a server (not shown) communicatively coupled to network 105 and the engines' functionality may be accessed from consumer device 110 via a web browser (not shown) or other technique. The data used by the engines, such as calendars 119, may reside locally on consumer device 110 or on a server (not shown) communicatively coupled to network 105.

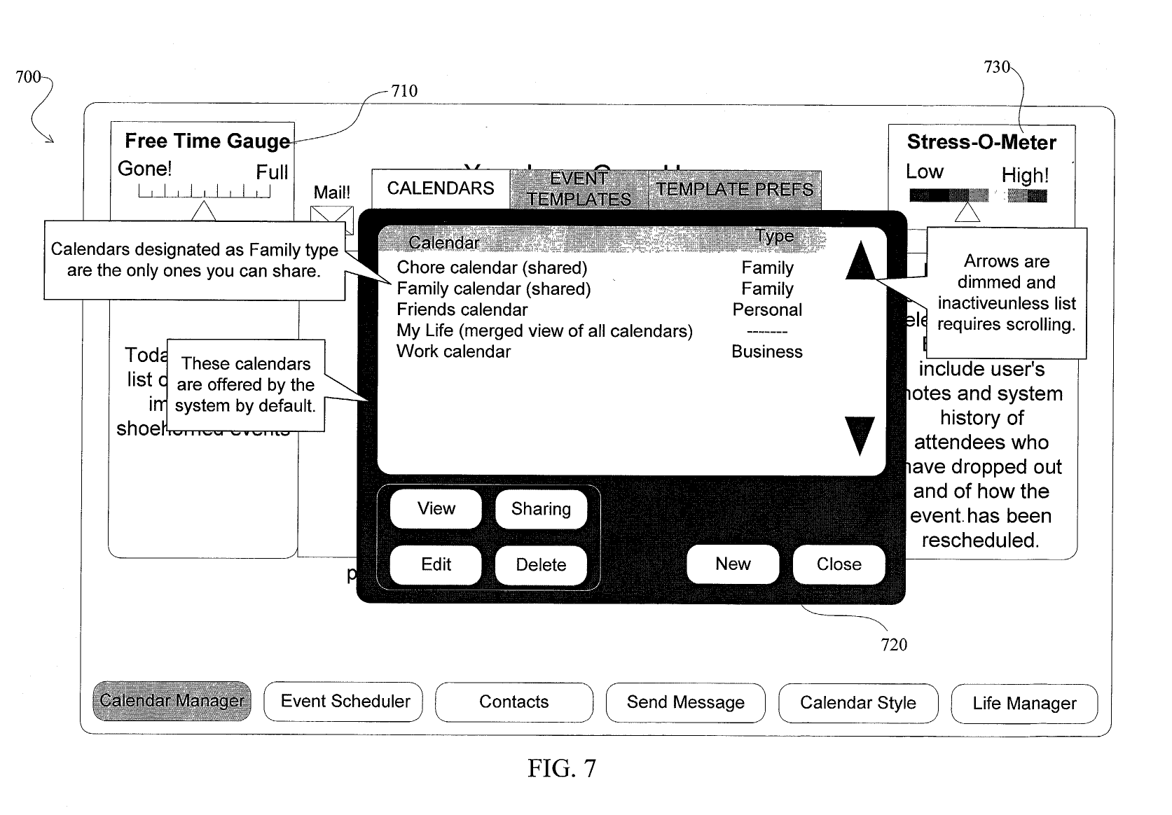

The calendaring engine 115 includes a calendar database 117 for storing events and a calendars file 119 for storing calendar preferences and customizations (e.g., graphics, default view, custom names for the calendars, etc.). The calendaring engine 115 enables a user to enter data into three separate calendars including a business calendar for showing business events, a personal calendar for showing personal events, and chores calendar for showing chores. The data entered for each calendar is stored in calendar database 117. A user can also have additional calendars including a family calendar and a friends calendar. Types of calendars will be discussed in further detail in conjunction with FIG. 7. The calendaring engine 115 enables a user to view the calendars in multiple formats, such as previous and upcoming days, weeks, months, and years. In addition the calendaring engine 115 enables a user to view daily, weekly and monthly calendars. When in a daily view, the calendaring engine 115 color codes events by type for easy view; shades block of work time; and tints new events or newly bumped events. In an embodiment of the invention, the calendaring engine can cause new or newly bumped events to blink. In an embodiment of the invention, the calendaring engine 115 also enables a user to view a meta-calendar showing events from all of the user's calendars in a single calendar.

In addition, the calendaring engine 115 enables a user to share calendars designated as family type with other users. For example, a user of consumer device 120 can view a family calendar on consumer device 110 if the user of consumer device 120 is a member of the same family as the user of consumer device 110. Determination of users allowed to view another user's family calendar is done via the portrait gallery engine 130, which will be discussed in further detail below.

The calendar database 117 stores scheduled events, such as telephone conferences calls, dates, laundry pickup times, etc. In addition, the calendar database 117 stores information associated with events, such as attendees, time, priority, event type, event location, etc.

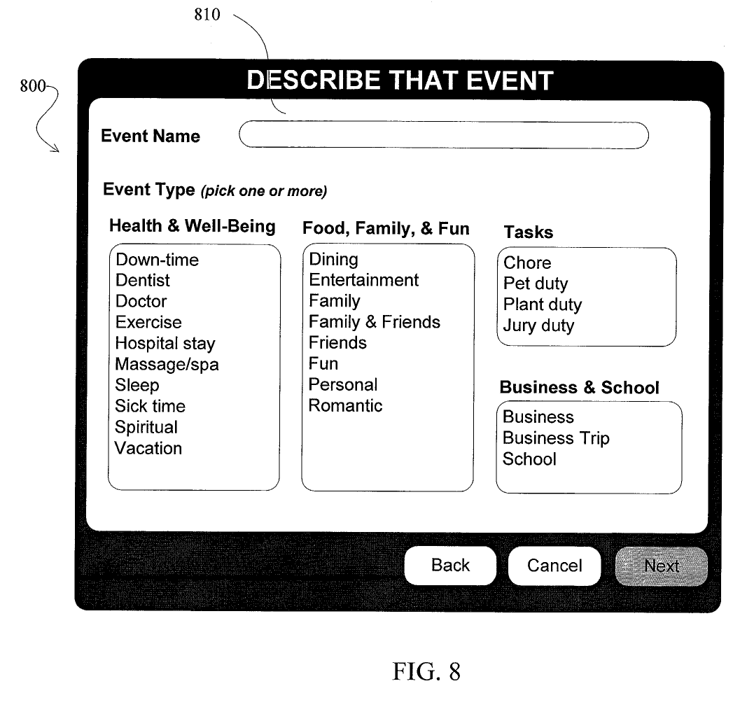

The event engine 121 includes templates 122 and preferences 124. The event engine 121 enables the user to schedule complex events and receive Triggered Services. A user can schedule a event using an event template from templates 122 or schedule an event without the use of a template. An example graphical user interface (GUI) for scheduling an event will be discussed with respect to FIG. 8 below. The user can specify event attributes, such as day, time frame, event beginning time, event ending time, amount of time, required and optional participants, level of importance for the event, stress level, event mode, event type, and event location. The user may instead choose to enter ranges and/or sets of options instead of specifying particulars, and then the system will choose the best attributes for the participants of the event. In addition, the user can revise any of the specified information and also bump the event by selecting a proposed bump day and time frame. After entering the relevant information, the event scheduler engine 121 sends invitations to the invitees, if any, who can then choose to accept or decline the invitations. In an alternative embodiment, the event engine 121 can access invitees' calendars and propose a bump day and time that meets everyone's schedule. If a user receives an invitation for an event, the user can accept or decline the invitation or have the event engine 121 automatically determine whether to accept or decline based on criteria such as the user's calendar, preferences 124 and inviter profile, as will be discussed further below.

Event engine 121 uses templates 122 to display an event's vital statistics for the purpose of enabling the user to quickly change any or all of the data and saving the changes as either a new event or an event template. In addition, a user can use templates 122 to generate new events by supplying all the necessary fields (date, time, priority, type of event, etc.) for user data entry.

Preferences 127 are set by a user and if set, enable life manager 125 to automatically schedule events in response to invitations from other users. Life manager 125, when receiving an invitation, first determines if it is allowed to accept or reject the invitation based on preferences 127. If the preferences 127 is set, then the life manager 125 determines the user's availability by examining the calendar database 117 for free time and also examining the user's portrait database 132 to examine the inviter's portrait, which will be discussed further below. For example, if a user receives an invitation for an event scheduled next Tuesday at 1 PM, the life manager 125 first determines if it is authorized to accept or decline the invitation by looking up preferences 127. If the life manager 125 is not authorized, the life manager 125 queries the user whether he or she wishes to accept. If the life manager 125 is authorized, then the life manager 125 first looks up the user's portrait for the inviter in database 132 to determine the nature of the relationship (e.g., friendly or not). If the portrait indicates that the relationship is acceptable, the life manager 125 then examines the user's schedule in calendar database 117 to determine if the user is available at the time of the event (e.g., next Tuesday at 1 PM). If the user is available, then the life manager 125 may accept the invitation, notify the inviter of the acceptance, and add the event to the user's calendar by updating database 117 to reflect the newly scheduled event.

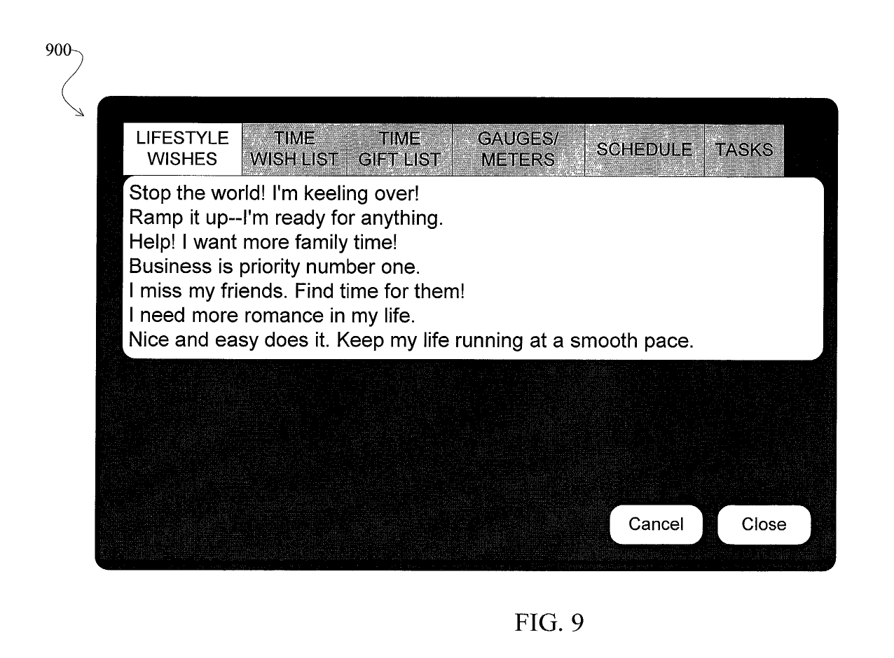

The life manager engine 125 also provides task wizards 129 to enable a user to define who in each family can do which tasks, such as picking up children from school and how long tasks generally take. In addition, the life manager engine 125 enables a user to set lifestyle intentions, stored in preferences 127, such as “Stop the World,” “Ramp It Up,” “More Family Time,” “Business is Priority Number One,” “Find Time for my Friends,” and “I Need More Romance in My Life.” Selection of lifestyle intentions will be discussed further in conjunction with FIG. 9 below. Further, the life manager 125 enables a user to set their ideal number of hours of sleep; ideal number of daily meals; weekly work schedule; work address so as to calculate drive time; set preferences on meters/gauges (such as a free time gauge; stress meter; family time gauge; and “love-o-meter”) to warn a user when values exceed or fall below set preferences. The gauges reflect day, week, or month depending on what calendar view the user is using.

The life manager engine 125 can control how incoming events are prioritized, accepted, or rejected based on lifestyle intentions that were set by a user. Further, the life manager engine 125 can prioritize, accept or reject incoming events based on implicit events related to the incoming event, such as travel time, meals, necessary breaks; sleep schedule; weather; family/pet distractions; casual vs. business meetings; alertness factor; and optimum driving/commuting times.

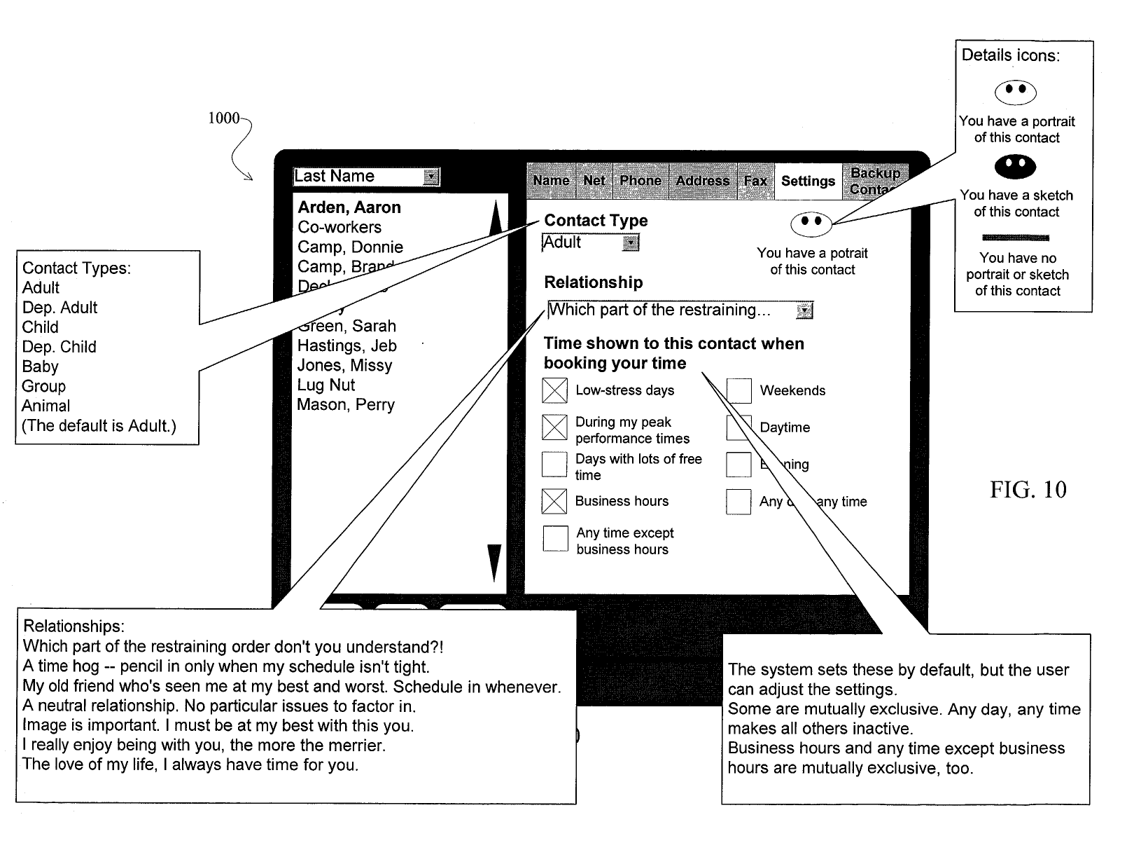

The portrait gallery engine 130 maintains contact information for other users. A user may enter data about users into a portrait gallery database 132. Alternatively, or in addition, the engine 130 may import contacts from Outlook and/or vCards from email into database 132. A user can define contacts by including such information as type of living organism (e.g., adult; dependent adult; child; dependent child; baby; animal/pet; etc.), individual relationship (romantic, friend; business colleague; “time hog”; neutral, etc.), emotional relationships (e.g. “Which part of the restraining order don't you understand?!”, “The Love of My Life, I Always Have Time for You,” etc.), and time shown to the contact when the contact wants to schedule an event with the user. Defining contacts will be discussed in further detail in conjunction with FIG. 10. Alternatively, the individual relationship may be specified numerically with a high number representing an important person (e.g., boss, close friend, significant other), a low number representing an enemy (e.g., harasser), or a middle number (e.g., colleague). In addition, the portrait gallery engine 130 enables the user to form groups of contacts and define information about the groups similarly to defining information about individual contacts. Other engines, as discussed above and further below, use portraits in portrait gallery database 132.

The voicemail engine is a Triggered Service and uses Event Templates to determine whether to let a phone call ring through or go to voicemail. This decision is based on criteria such as the user's defined emotional and traditional relationships with the caller, the profile of the event currently scheduled on the user's calendar (e.g. are they in the middle of a stressful meeting?) as well as the user's lifestyle setting

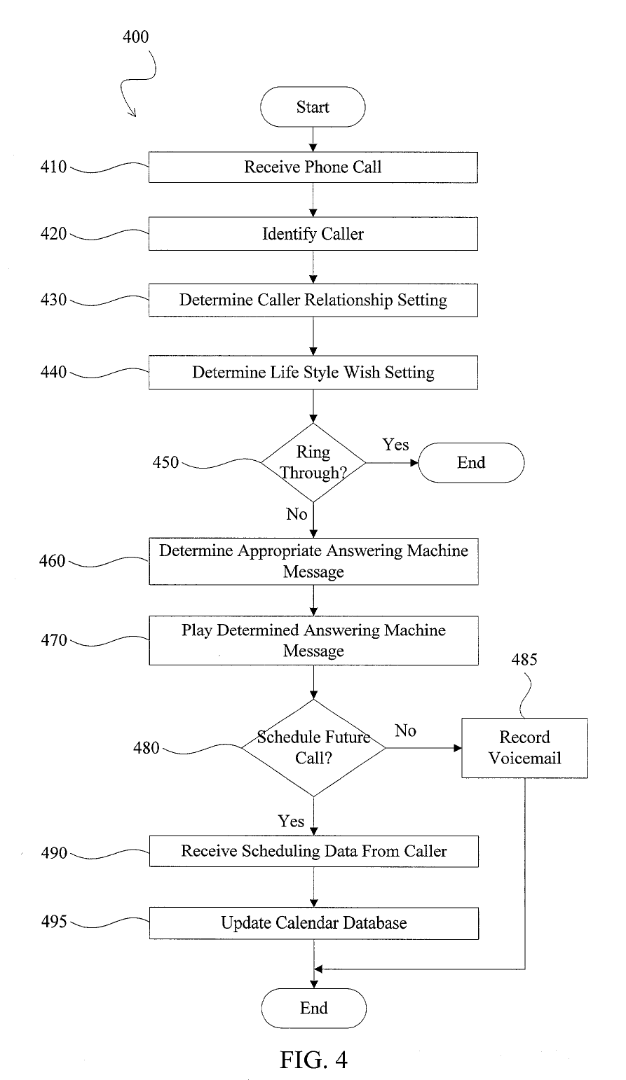

If the phone call is to go to voicemail, the voicemail engine 135 determines the appropriate answering machine message from answering machine messages 137 to play based on caller relationship, lifestyle setting, time shown (according to the caller's portrait) and available time for rescheduling according to the user's calendar, as will be discussed further in conjunction with FIG. 4. If engine 135 records a voicemail, the recorded voicemail can be stored in stored voicemails 139 for later playback.

The call scheduler engine 140 works similarly to the event engine 120 in that it enables a user to schedule a telephone conference with multiple invitees and reschedule if an invitee isn't available to make the conference. The rescheduling can be based on a user's preference or based on invitees' availability according to their calendars. The call scheduler engine 140 can also examine other users' calendars to determine availability for rescheduling. The call scheduler engine 140 may also limit rescheduling to the time shown preference set for the other users' portraits.

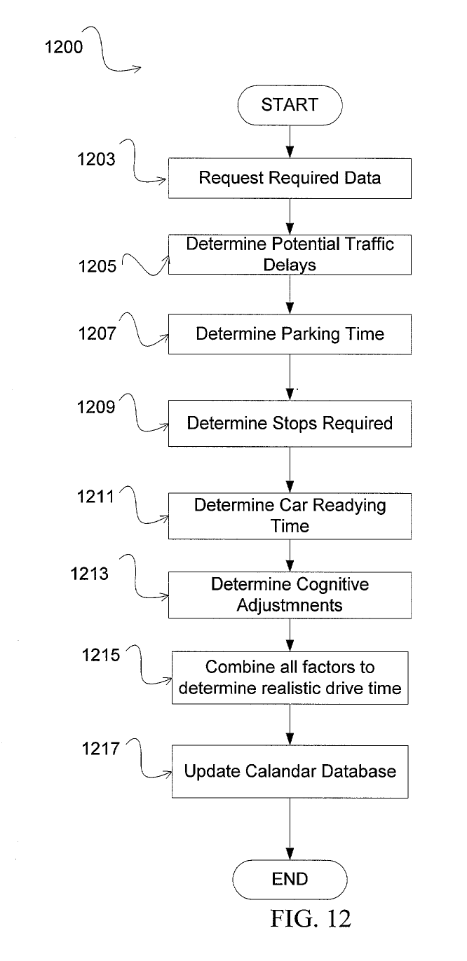

The information gathering engine 145, in response to requests for data from other engines, gathers information from databases stored locally and/or remotely and feeds that data to the requesting engine. For example, the engine 145 collects information such as driving directions, raw drive times from point A to point B and the population density at Point A and B. These are used as a basis for calculating the additional cognitive time dependencies such as bathroom breaks, food requirements during the trip, parking times, etc. by the drive time calculation engine 150, which will be discussed further in FIG. 12.

In an embodiment of the invention, consumer device 110 may also include a persistent java bar engine (not shown) that provides a floating Java application that allows enable calendar users quick access to important status information (such as the number of received voicemails, emails and faxes. Short text messages such as headline news and sports and personal reminders and notes may also appear in the bar in a “news ticker” style. When invitations to join an event or telephone conference, the persistent java bar engine may display the invitation or an appropriate button to take the user to an RSVP page.

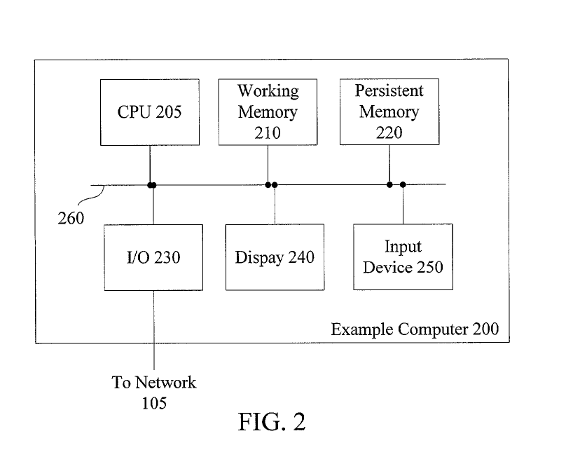

FIG. 2 is a block diagram illustrating an example computer 200 in accordance with the present invention. In an embodiment of the invention, engines 115, 121, 125, 130, 135, 140, 145 and 150 may include or be resident on example computer 200. The example computer 200 includes a central processing unit (CPU) 205; working memory 210; persistent memory 220; input/output (I/O) interface 230; display 240 and input device 250, all communicatively coupled to each other via system bus 260. CPU 205 may include an Intel Pentium® microprocessor, a Motorola Power PC® microprocessor, or any other processor capable to execute software stored in persistent memory 220. Working memory 210 may include random access memory (RAM) or any other type of read/write memory devices or combination of memory devices. Persistent memory 220 may include a hard drive, read only memory (ROM) or any other type of memory device or combination of memory devices that can retain data after example computer 200 is shut off. I/O interface 230 is communicatively coupled, via wired or wireless techniques, to network 105, thereby enabling communications between example computer 200 and other devices.

Display 240 may include a cathode ray tube display or other display device. Input device 250 may include a keyboard, mouse, or other device for inputting data, or a combination of devices for inputting data.

One skilled in the art will recognize that the example computer 200 may also include additional devices, such as network connections, additional memory, additional processors, LANs, input/output lines for transferring information across a hardware channel, the Internet or an intranet, etc. One skilled in the art will also recognize that the programs and data may be received by and stored in the system in alternative ways.

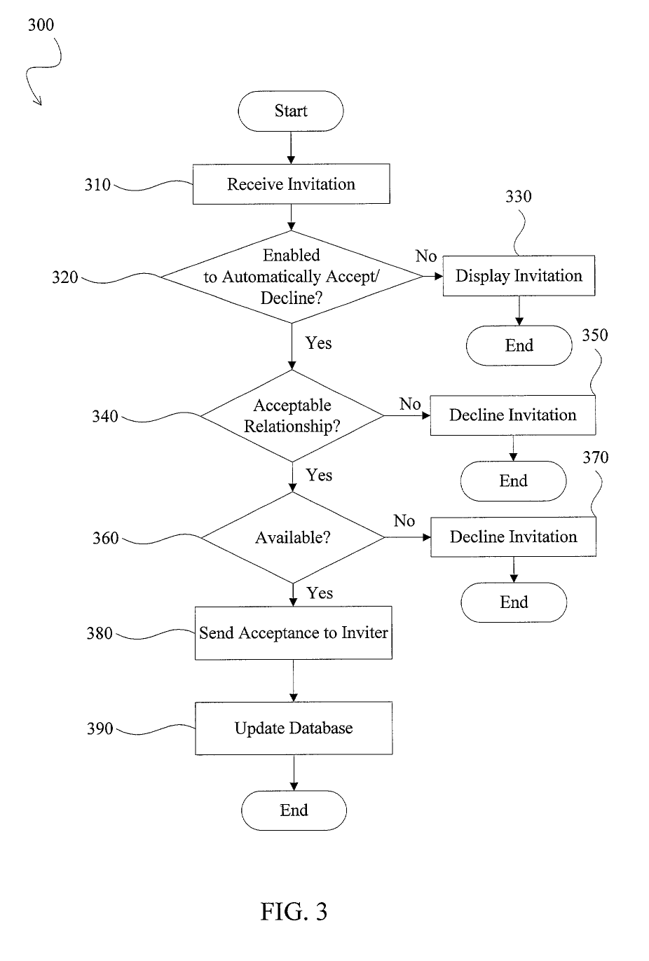

FIG. 3 is a flowchart illustrating a method 300 for processing a received event invitation. In an embodiment of the invention, life manager 125 performs method 300. Further, life manager 125 may run several instances of method 300 substantially simultaneously. Method 300 comprises receiving (310) an invitation. The invitation includes data such as time, date and location of the event and the inviter. The invitation may also include invitees and other information. Next, it is determined (320) if it is okay to automatically accept or decline the invitation without the user's intervention based on preferences set in preferences 127. If preferences are not set, then the invitation is displayed (330). If the preferences are set, then it is determined (340) if the inviter's relationship is set to an acceptable level to accept the invitation. This determination (340) can be done by looking up the portrait of the inviter in portrait gallery database 132. If the relationship setting is unacceptable, then the invitation is declined (350) by sending a decline message to the inviter.

If the relationship setting is acceptable, then it is determined (360) if the user has free time available to attend the event by examining the user's calendar database 117. If the user doesn't have time, then the invitation is declined (370) by sending a decline message to the inviter. If the user does have time, then an acceptance is sent (380) to the inviter and the database 117 is updated (390) to reflect the new event. The method 300 then ends.

FIG. 4 is a flowchart illustrating a method 400 for processing a phone call. In an embodiment of the invention, voicemail engine 135 may execute method 400. Further, engine 135 may run several instances of method 400 substantially simultaneously. First, a phone call is received (410). The caller is then identified (420) via Caller ID technology or via other techniques. The caller relationship is then determined (430) by looking up the caller's portrait in the portrait database 132. Next, the life style wish setting of the user is determined (440) by examining preferences set in preferences 127. Based on the relationship setting and the life style wish setting, it is determined (450) whether to ring through or not. For example, if a user has a positive relationship setting (e.g., the caller is the user's best friend) and the life style wish setting is set to “Bring it on, I'm ready for anything” then the call rings through and the method 400 ends. However, if the life style wish setting is set to “Do not disturb” then the call will go to voicemail.

If the call does go to voicemail, then the appropriate answering machine message to play is determined (460). The answering machine messages are stored in answering machine messages 137 and can be correlated for specific callers and/or relationship types. For example, a user may have an answering machine message for a significant other and a more serious answering message for a colleague. In addition, a user may have an answering message that issues a warning to a caller having a negative relationship. The answering machine message may also enable the caller to schedule a callback based on the user's availability. The determined answering machine message is then played (470).

If it is determined (480) to give the caller an option to schedule a callback based on time shown for the caller in the user's portrait database 132 and the user's availability based on scheduled events in the user's calendar, scheduling information is received (490) from the caller via touchtone input or voice recognition and then the calendar database 117 is updated (495). In addition, the caller may also leave a voicemail. If the caller is not given the option to schedule a callback, the caller may leave a voicemail, which is recorded (485) and stored in stored voicemails 139. The method 400 then ends.

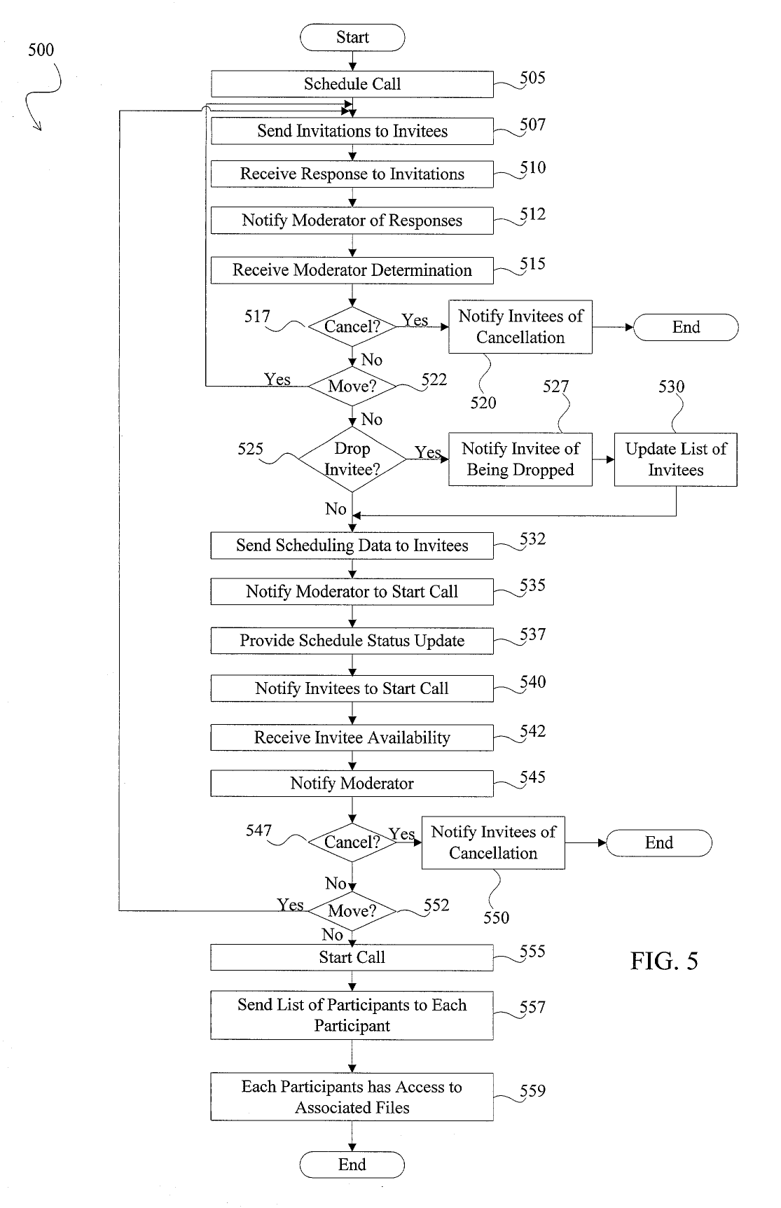

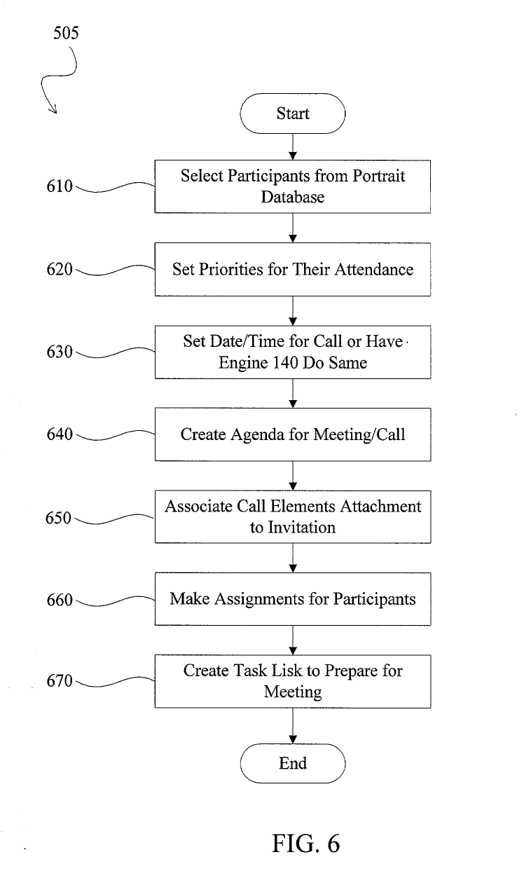

FIG. 5 is a flowchart illustrating a method 500 for arranging and holding a telephone conference. In an embodiment of the invention, call scheduler engine 140 executes method 500. Further, engine 140 may execute multiple instances of method 500 substantially simultaneously. The method 500 comprises first scheduling (505) a call, which will be described in further detail in conjunction with FIG. 6. Next, invitations are sent (507) to the invitees. Responses to the invitations are then received (510). The moderator (i.e., inviter) is then notified of the responses to the invitations, which may include acceptances, rejections, and requests to reschedule. The moderator can then make a determination whether to proceed, reschedule (e.g., bump or move the call), or cancel the call. This decision is then received (515). If the received decision is to cancel (517) the call, then the invitees are notified (520) of the cancellation and the method 500 ends. If the received decision is to move (522) the call to another time, the method 500 proceeds to sending (507). Otherwise, if the decision is to drop (525) an invitee that can't make the meeting, then the invitee (527) is notified of being dropped and a list of invitees is updated accordingly.

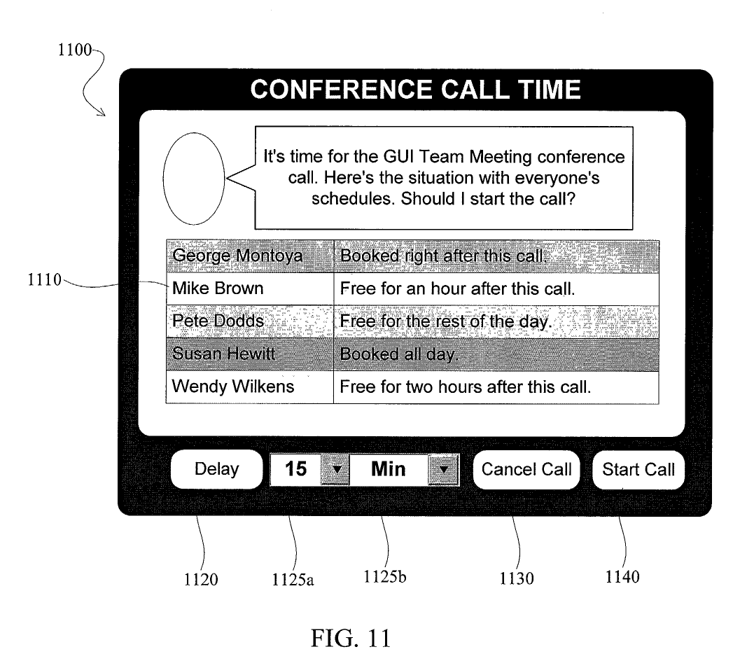

Scheduling data is then sent (532) to the invitees. At the appropriate time, the moderator (inviter) is notified (535) to start the call and a schedule status update is provided (537) that shows the impact of delaying the call (an example GUI 1100 showing the impact of delaying a call is shown in FIG. 11). For example, if an invitee is fully booked for the rest of the day, it will be hard to delay the start of the call. The invitees are then notified (540) to start the call. Invitee availability is then received (545) and the moderator is notified (547) of real time invitee availability. Based on this notification, the moderator may cancel (547) the call, at which point the invitees are notified (550) of such and the method 500 ends. Alternatively, the moderator may decide to move (552) the call, at which point the method 500 returns to sending (507). If the moderator decides not to cancel (547) and not to move (552), then the call is started (555) and a list of participants is sent (557) to all the participants and each participant now has access to associated files (559). The method 500 then ends.

FIG. 6 is a flowchart illustrating a method 505 for scheduling a telephone conference. First, users (invitees) are selected (610) from the portrait database 132. In addition, or alternatively, users may be selected via other techniques. Priorities are then set (620) for their attendance. Date/Time is then set (630) for the invitees. In an alternative embodiment of the invention, engine 140 may access all of the invitees' calendars and determine a time when all the invitees or all of the invitees with highest priority are available. Engine 140 may be limited to scheduling the calls though according to the invitee's portrait settings for the inviter.

Next, an agenda is created (640) for the meeting/call. Call elements, such as files, are then attached (650) to an invitation. Assignments are then made (660) for the invitees/participants and a task list to prepare for the meeting is created (670). The method 505 then ends.

FIG. 7 is a diagram illustrating an example graphical user interface (GUI) 700 for calendar selection. The GUI 700 includes a calendar selection window 720 listing several calendars including chore calendar, a family calendar, a friends calendar, a My Life calendar, and a work calendar. The chore and family calendar are of type family and so can be shared. The family calendar is a personal calendar and therefore cannot be shared with other users. The My Life calendar is a meta-calendar listing events from all other calendars. Work calendar is calendar of business events and cannot be shared with the family. Also shown in GUI 700 is a Free Time Gauge 710 that indicates the amount of overall free time based on calendared events and a Stress-O-Meter 730 corresponding to the amount of events in the near future.

FIG. 8 is a diagram illustrating an example GUI 800 for scheduling an event. A user can enter the event name in field 810 and then select one or more event types from “Health & Well Being,” “Food, Family, & Fun,” “Tasks,” “Business & School,” and “Telephony.” Other GUIs (not shown) are used to enter time of the event, invitees, etc.

FIG. 9 is a diagram illustrating an example GUI 900 for selecting a lifestyle intention or wish that is stored in preferences 127. GUI 900 enables a user to select a lifestyle wish corresponding to what is most important to the user at the time. For example, by selecting “Business is priority number one,” a user is specifying that business is most important. Therefore, for example, if a user received a call from a business colleague, voicemail engine 135 would allow the call to ring through. However, if the call was from a friend, voicemail engine 135 may not let the call ring through depending on portrait settings for the caller. Alternatively, selecting “Stop the world! I'm keeling over!”may cause voicemail engine 135 to send all calls to voicemail.

FIG. 10 is a diagram illustrating an example portrait GUI 1000 for a contact. The GUI 1000 indicated the contact type is an adult having a relationship of “What part of the restraining order . . . ” indicating a negative relationship and therefore limited the contact's ability to schedule events with the user and leave voicemails for the user. The GUI 1000 also lists time shown to the contact as low-stress days; my peak performance times, and business hours. If the contact was for a significant other, the relationship might instead be set to “The love of my life . . . ” and time shown might be set to Any Day, Any Time.

FIG. 11 is a diagram illustrating an example GUI 1100 illustrating impact of delaying a scheduled telephone conference based on invitees' availability. The invitees' availability is shown in table 1110. The user can then determine to delay the call by pressing a delay button 1120, cancel the call by pressing a cancel button 1130, or start the call by pressing a start call button 1140. Further, if the user decides to delay the telephone conference, the user can specify the amount of the delay by setting 1125a and 1125b.

FIG. 12 is a flowchart illustrating a method 1200 for calculating a realistic drive time to, between or from scheduled events. First, the system requests the information gathering engine (145) for data like raw drive time estimates (1203). Next, it checks databases for factors that could affect drive time such as weather, traffic accidents, holidays, and time of day (1205). The information gathering engine (145) also gathers any available information about how urban the area is, if there's any nearby parking structures or typical parking crowding (1207). The system also takes into account any implicit or explicit events that would cause the driver to stop along the way, such as getting gas, getting fast-food, or stopping for bio-breaks (1209). Car-readying time (1211) such as loading kids in the car or defrosting the car is also taken into account. Cognitive adjustments (1213) such as personal preferences to always arrive a bit early, or a tendency to get lost are also factored in. Finally, all these factors are combined to calculate a realistic estimated drive time (1215). This time is now added to the user's calendar as an implicit event linked to the explicit events and the calendar database 117 is updated (1217). Driving directions may also be linked to the event on the calendar.

The foregoing description of the embodiments of the present invention is by way of example only, and other variations and modifications of the above-described embodiments and methods are possible in light of the foregoing teaching. For example, call scheduler engine 141 may be used to schedule videoconference in addition to telephone conferences. Although the network sites are being described as separate and distinct sites, one skilled in the art will recognize that these sites may be a part of an integral site, may each include portions of multiple sites, or may include combinations of single and multiple sites. Further, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A computer-based method, comprising:
receiving a telephone call;
identifying the caller; and
determining a caller relationship setting.

2. The method of claim 1, further comprising determining a user's life wish setting.

3. The method of claim 1, further comprising determining a user's current calendar event.

4. The method of claim 1, further comprising enabling the telephone call to ring through as a function of the caller relationship setting.

5. The method of claim 2, further comprising enabling the telephone call to ring through as a function of the caller relationship setting and the user's life wish setting.

6 The method of claim 2, further comprising determining the user's current calendar event.

7. The method of claim 2, further comprising:
determining a user's current calendar event; and
enabling the telephone call to ring through as a function of the caller relationship setting, user's current calendar event and the user's life wish setting

8. The method of claim 3, further comprising enabling the telephone call to ring through based upon the relationship setting and the current calendar event.

9. The method of claim 6, further comprising sending the telephone call to voicemail if the telephone call is not enabled to ring through.

10. The method of claim 7, further comprising sending the telephone call to voicemail if the telephone call is not enabled to ring through.

11. The method of claim 8, further comprising sending the telephone call to voicemail if the telephone call is not enabled to ring through.

12. The method of claim 9, further comprising determining an answering machine message to play if the call is sent to voicemail, the determining an answering machine message being a function of lifestyle wish setting and caller relationship setting.

13. The method of claim 10, further comprising determining an answering machine message to play if the call is sent to voicemail, the determining an answering machine message being a function of lifestyle wish setting and caller relationship setting.

14. The method of claim 11, further comprising determining an answering machine message to play if the call is sent to voicemail, the determining an answering machine message being a function of lifestyle wish setting and caller relationship setting.

15. The method of claim 12, further comprising sending schedule availability information to the caller if the call is not enabled to ring through, the schedule availability information based on the caller relationship setting and a user's availability as indicated in a calendar database.

16. The method of claim 13, further comprising sending schedule availability information to the caller if the call is not enabled to ring through, the schedule availability information based on the caller relationship setting and a user's availability as indicated in a calendar database.

17. The method of claim 14, further comprising sending schedule availability information to the caller if the call is not enabled to ring through, the schedule availability information based on the caller relationship setting and a user's availability as indicated in a calendar database.

18. The method of claim 15, further comprising:
receiving a response to the sent schedule availability information, the response including a date and time for a telephone call;
updating the calendar database to include the date and time for the telephone call.

19. The method of claim 16, further comprising:
receiving a response to the sent schedule availability information, the response including a date and time for a telephone call; updating the calendar database to include the date and time for the telephone call

20. The method of claim 17, further comprising:
receiving a response to the sent schedule availability information, the response including a date and time for a telephone call;
updating the calendar database to include the date and time for the telephone call.

21. A computer-based method, comprising:
receiving an invitation to an event, the invitation including the time and date of the event and an inviter's name;
determining if an automated acceptance preference is set;
determining a relationship setting for the inviter;
determining a life style wish setting;
determining if free time available to attend the event by looking up the time and date of the event in a calendar database;
sending an acceptance to the inviter as a function of the automated acceptance preference, free time, monitors and gauges, life style wishes, and relationship setting; and
updating the calendar database to include the event if an acceptance is sent.

22. The method of claim 21, further comprising displaying the invitation if the automated acceptance preference is not set.

23. The method of claim 21, further comprising declining the invitation if an acceptance is not sent.

24. A computer-based method, comprising:
receiving, from invitees, responses to a conference invitation;
sending confirmations to invitees that signal acceptance;
sending, to the invitees, notifications of start of the conference;
determining the impact of delaying the start of the conference; and
displaying the impact of delaying the conference.

25. The method of claim 24, wherein the conference includes a telephone conference.

26. The method of claim 24, wherein the determining includes accessing invitees' calendar databases to determine the invitees' availabilities.

27. The method of claim 24, wherein the determining includes accessing invitees' calendar databases, life style wishes, monitors and gauges, and relationship settings to determine the invitees' preferred time availabilities.

28. The method of claim 24, wherein the conference invitation includes a date and time selected by a use

29. The method of claim 24, further comprising sending a list of participants to the invitees

30. A system communicatively coupled to a network, comprising:
a calendar engine capable to store and display event data from a calendar database;
a portrait database capable to store portraits of users; the portraits including relationship settings for users; and
an event engine, communicatively coupled to the calendar engine and portrait database, capable to respond to an event invitation received, via the network, from an inviter as a function of time availability as indicated in the calendar database and relationship setting of the invitee as indicated in the portrait database.

31. The system of claim 30, further comprising a life style wish preference file capable to store a life style wish set by a system user.

32. The system of claim 31, further comprising a voicemail engine, communicatively coupled to the calendar engine, the life style wish preference file, and the portrait database, capable to receive a phone call, identify the caller, wherein the caller is a user, and determine whether to let the phone call ring through as a function of the life style wish and the caller relationship setting.

33. The system of claim 32, wherein the voicemail engine is further capable to send the phone call to voicemail if it is determined not to let the phone call ring through.

34. The system of claim 33, wherein the voicemail engine is further capable to select an answering machine message as a function of caller relationship setting when the phone call is sent to voicemail.

35. The system of claim 34, wherein the voicemail engine is further capable to notify the caller of available free time to reschedule a call as a function of available free time per the calendar database and of the caller relationship.

36. The system of 31, further comprising a conference scheduler engine communicatively coupled to the calendar engine, the portrait database and the life style wish preference file, the conference scheduler engine capable to send, via the network, invitations to invitees, wherein the invitees are users; receive replies to the invitations; and send scheduling data to the invitees.

37. The system of claim 36, wherein the conference scheduler engine is capable to determine a time and date for a conference by determining availability of invitees by examining their respective calendar databases.

38. The system of claim 37, wherein the calendar engine is further capable to update the calendar database to include the conference.

39. The system of claim 38, wherein the conference scheduler engine is further capable to display a schedule status update showing the impact of delaying a scheduled conference, wherein the update includes schedules of invitees as indicated in their respective calendar databases.

40. A computer-based method, comprising
examining a calendar entry; and
selecting one or more services appropriate to the event.

41. The method of claim 40, further comprising offering the services to a user.

42. The method of claim 41, further comprising launching services selected by the user.

43. The method of claim 41, further comprising collecting choices of services from the user and launching those services.

44. A computer-readable medium storing computer-executable code to execute a method, the method comprising:
receiving a telephone call;
identifying the caller; and
determining a caller relationship setting.

45. The computer-readable medium of claim 44, further comprising determining a user's life wish setting.

46. The computer-readable medium of claim 44, further comprising determining a user's current calendar event.

47. The computer-readable medium of claim 44, further comprising enabling the telephone call to ring through as a function of the caller relationship setting.

48. The computer-readable medium of claim 45, further comprising enabling the telephone call to ring through as a function of the caller relationship setting and the user's life wish setting.

49 The computer-readable medium of claim 45, further comprising determining the user's current calendar event.

50. The computer-readable medium of claim 45, further comprising:
determining a user's current calendar event; and
enabling the telephone call to ring through as a function of the caller relationship setting, user's current calendar event and the user's life wish setting

51. The computer-readable medium of claim 46, further comprising enabling the telephone call to ring through based upon the relationship setting and the current calendar event.

52. The computer-readable medium of claim 49, further comprising sending the telephone call to voicemail if the telephone call is not enabled to ring through.

53. The computer-readable medium of claim 50, further comprising sending the telephone call to voicemail if the telephone call is not enabled to ring through.

54. The computer-readable medium of claim 51, further comprising sending the telephone call to voicemail if the telephone call is not enabled to ring through.

55. The computer-readable medium of claim 52, further comprising determining an answering machine message to play if the call is sent to voicemail, the determining an answering machine message being a function of lifestyle wish setting and caller relationship setting.

56. The computer-readable medium of claim 53, further comprising determining an answering machine message to play if the call is sent to voicemail, the determining an answering machine message being a function of lifestyle wish setting and caller relationship setting.

57. The computer-readable medium of claim 54, further comprising determining an answering machine message to play if the call is sent to voicemail, the determining an answering machine message being a function of lifestyle wish setting and caller relationship setting.

58. The computer-readable medium of claim 55, further comprising sending schedule availability information to the caller if the call is not enabled to ring through, the schedule availability information based on the caller relationship setting and a user's availability as indicated in a calendar database.

59. The computer-readable medium of claim 56, further comprising sending schedule availability information to the caller if the call is not enabled to ring through, the schedule availability information based on the caller relationship setting and a user's availability as indicated in a calendar database.

60. The computer-readable medium of claim 57, further comprising sending schedule availability information to the caller if the call is not enabled to ring through, the schedule availability information based on the caller relationship setting and a user's availability as indicated in a calendar database.

61. The computer-readable medium of claim 58, further comprising:
receiving a response to the sent schedule availability information, the response including a date and time for a telephone call;
updating the calendar database to include the date and time for the telephone call.

62. The computer-readable medium of claim 59, further comprising:
receiving a response to the sent schedule availability information, the response including a date and time for a telephone call; updating the calendar database to include the date and time for the telephone call

63. The computer-readable medium of claim 60, further comprising:
receiving a response to the sent schedule availability information, the response including a date and time for a telephone call;
updating the calendar database to include the date and time for the telephone call.

64. A computer-readable medium storing computer-executable code to execute a method, the method comprising:
receiving an invitation to an event, the invitation including the time and date of the event and an inviter's name;
determining if an automated acceptance preference is set;
determining a relationship setting for the inviter;
determining a life style wish setting;
determining if free time available to attend the event by looking up the time and date of the event in a calendar database;
sending an acceptance to the inviter as a function of the automated acceptance preference, free time, monitors and gauges, life style wishes, and relationship setting; and
updating the calendar database to include the event if an acceptance is sent.

65. A computer-readable medium storing computer-executable code to execute a method, the method comprising:
receiving, from invitees, responses to a conference invitation;
sending confirmations to invitees that signal acceptance;
sending, to the invitees, notifications of start of the conference;
determining the impact of delaying the start of the conference; and
displaying the impact of delaying the conference.
